(19) United States
(12) Patent Application Publication
(10) Pub. No.: US 2025/0218645 A1
(43) Pub. Date: Jul. 3, 2025

(54) INDUCTOR AND DC-DC CONVERTER

(71) Applicant: TDK Corporation, Tokyo (JP)

(72) Inventors: Tomofumi KURODA, Tokyo (JP); Hajime KUWAJIMA, Tokyo (JP); Atsushi KOYAMA, Tokyo (JP); Haruka AIBA, Tokyo (JP)

(73) Assignee: TDK Corporation, Tokyo (JP)

(21) Appl. No.: 19/001,920

(22) Filed: Dec. 26, 2024

(30) Foreign Application Priority Data
Dec. 28, 2023 (JP) 2023-222844

(51) Int. Cl. H01F 27/28; H01F 27/24; H02M 3/00

(52) U.S. Cl. CPC H01F 27/28; H01F 27/24; H02M 3/003

(57) ABSTRACT

An inductor includes a magnetic body having a corner portion and disposed such that the corner portion faces the connection conductor of the coil conductor, and a resin member disposed between the magnetic body and the first conductor of the coil conductor, in which at least one conductor of the first conductor and the second conductor has a first recessed portion recessed from an inside to an outside at a position adjacent to the connection conductor, and a dimension of the first recessed portion in a third direction intersecting the first and second directions is equal to or larger than a dimension of a conductor having a shorter dimension in the third direction, of the one conductor and the other conductor, in the third direction.

### CROSS-REFERENCE TO RELATED APPLICATION

This application is based upon and claims the benefit of priority from Japanese Patent Application No. 2023-222844, filed on Dec. 28, 2023, the entire contents of which are incorporated herein by reference.

### TECHNICAL FIELD

The present disclosure relates to an inductor and a DC-DC converter.

### BACKGROUND

Conventionally, there is an inductor disclosed in Japanese Unexamined Patent Publication No. 2022-33703. The inductor includes a coil conductor and a magnetic body serving as a core. The coil conductor has a bent portion.

### SUMMARY

An inductor according to one aspect of the present disclosure includes a coil conductor including a first conductor extending in a first direction, a second conductor extending in a second direction intersecting the first direction, and a connection conductor connecting one end portion of the first conductor and one end portion of the second conductor; a magnetic body having a corner portion and disposed such that the corner portion faces the connection conductor of the coil conductor; and a resin member disposed between the magnetic body and the first conductor of the coil conductor, in which at least one conductor of the first conductor and the second conductor has a first recessed portion recessed from an inside to an outside at a position adjacent to the connection conductor, and a dimension of the first recessed portion in a third direction intersecting the first and second directions is equal to or larger than a dimension of a conductor having a shorter dimension in the third direction, of the one conductor and the other conductor, in the third direction.

A DC-DC converter according to one aspect of the present disclosure includes the inductor described above.

### BRIEF DESCRIPTION OF THE DRAWINGS

FIG. 1 is a perspective view of an inductor according to the present embodiment;

FIG. 2 is a development view of an inductor;

FIG. 3 is a diagram illustrating a circuit of a DC-DC converter using the inductor illustrated in FIG. 1;

FIG. 4 is a cross-sectional view taken along line IV-IV of FIG. 1;

FIGS. 5A to 5E are cross-sectional views illustrating inductors according to a modification example;

FIGS. 6A to 6C are cross-sectional views illustrating inductors according to a comparative example;

FIGS. 7A to 7C are cross-sectional views illustrating inductors according to a comparative example;

FIG. 8 is a cross-sectional view illustrating an inductor according to a modification example;

FIG. 9A is a cross-sectional view illustrating an inductor according to a modification example, and FIG. 9B is a cross-sectional view illustrating an inductor according to a comparative example;

FIG. 10 is a cross-sectional view illustrating an inductor according to a modification example;

FIG. 11 is a cross-sectional view illustrating an inductor according to a modification example;

FIGS. 12A and 12B are cross-sectional views illustrating inductors according to a modification example;

FIG. 13 is a development view illustrating an inductor according to a modification example; and

FIG. 14 is a diagram illustrating a circuit of a DC-DC converter according to a modification example.

### DETAILED DESCRIPTION

Here, in the inductor, a resin member serving as an insulating member may be disposed between the coil conductor and the magnetic body. In such a resin member, a burr that protrudes from the end portion of the conductor of the coil conductor may be formed. When the burr of the resin member is interposed in the portion where the coil conductor is bent, a positional relationship between the coil conductor and the magnetic body may deviate. There is a problem that stable magnetic characteristics cannot be obtained due to deviation in a positional relationship between the coil conductor and the magnetic body.

Therefore, an object of the present disclosure is to provide an inductor and a DC-DC converter capable of obtaining stable magnetic characteristics.

According to one aspect of the present disclosure, it is possible to provide an inductor and a DC-DC converter capable of obtaining stable magnetic characteristics.

Hereinafter, some embodiments of the present disclosure will be described in detail. In this regard, the present disclosure is not limited to the following embodiments.

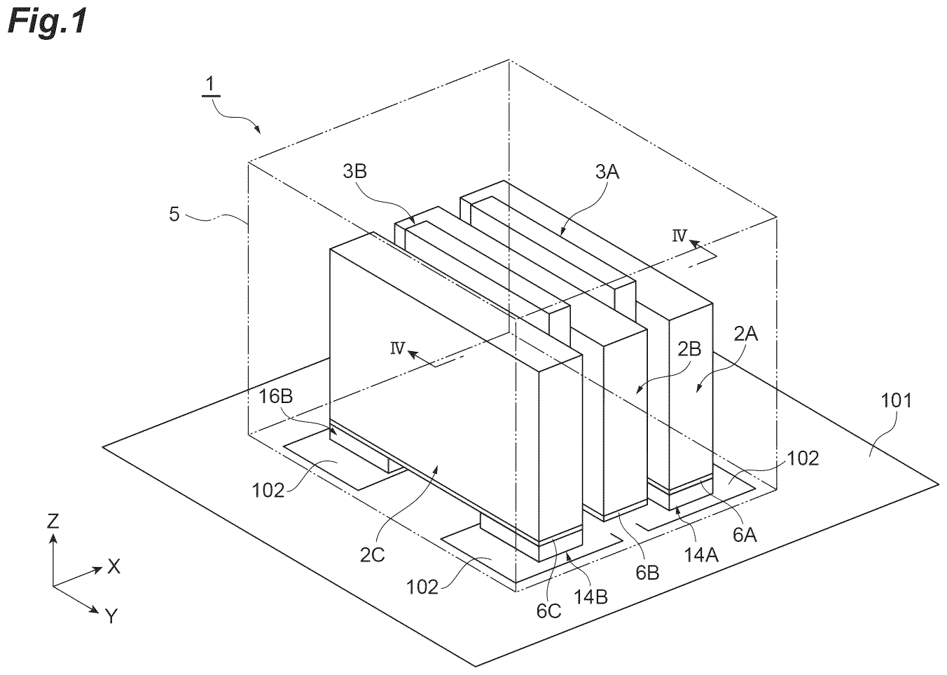

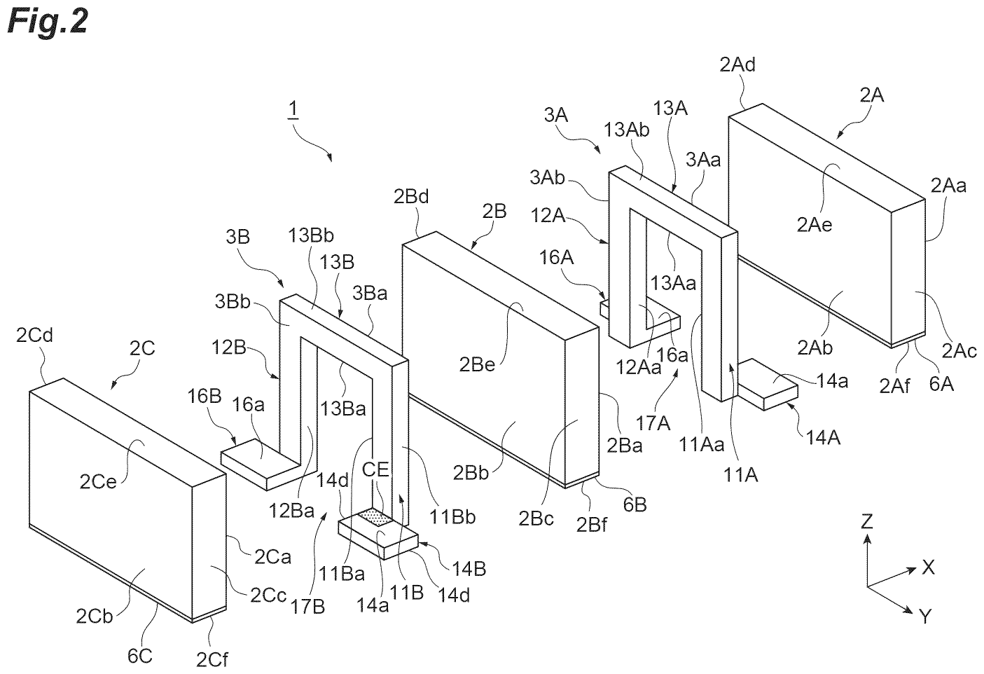

First, a schematic configuration of an inductor 1 according to the present embodiment will be described with reference to FIGS. 1 and 2. FIG. 1 is a perspective view of an inductor 1 according to the present embodiment. FIG. 2 is a development view of the inductor 1. FIG. 1 illustrates a state in which the inductor 1 is mounted on a substrate 101. The inductor 1 according to the present embodiment is formed by stacking magnetic bodies 2A, 2B, and 2C and coil conductors 3A and 3B in an X-axis direction. In the present embodiment, the X-axis direction, a Y-axis direction, and a Z-axis direction are orthogonal to each other. In the present embodiment, the X-axis direction corresponds to a “first direction” in the claims, the Z-axis direction orthogonal to the X-axis direction corresponds to a “second direction” in the claims, and the Y-axis direction orthogonal to the X-axis direction and the Z-axis direction corresponds to a “third direction” in the claims.

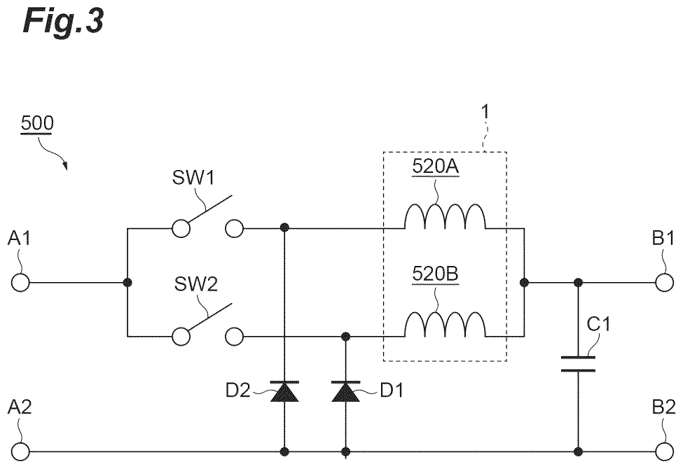

As illustrated in FIG. 1, the inductor 1 includes a magnetic body 2A, a magnetic body 2B, a magnetic body 2C, a coil conductor 3A, a coil conductor 3B, a resin material 5, a resin member 6A, a resin member 6B, and a resin member 6C. In FIG. 1, the resin material 5 is indicated by a virtual line in order to facilitate understanding of the features. The inductor 1 may be adopted as a choke coil of a circuit of the DC-DC converter 100 illustrated in FIG. 3.

The magnetic body 2A and the magnetic body 2B are disposed to face each other while being separated from each other in the X-axis direction. The magnetic body 2B and the magnetic body 2C are disposed to face each other while being separated from each other in the X-axis direction. The magnetic bodies 2A, 2B, and 2C are arranged in order from the positive side in the X-axis direction. The magnetic bodies 2A, 2B, and 2C have rectangular parallelepiped shapes. The magnetic bodies 2A, 2B, and 2C have the same shape. The magnetic bodies 2A, 2B, and 2C may be made of, for example, a magnetic material such as a sintered magnetic core such as MnZn-based ferrite or NiZn-based ferrite or a multilayer magnetic core formed by laminating soft magnetic metal plates. The magnetic permeability of the magnetic bodies 2A, 2B, and 2C may be 1000 or more. The magnetic bodies 2A, 2B, and 2C may have substantially the same or different magnetic characteristics.

The pair of coil conductors 3 (3A and 3B) included in the inductor 1 may be adopted for each choke coil of a circuit of a DC-DC converter 500 illustrated in FIG. 3. The DC-DC converter 500 is a multiphase converter including a pair of conversion portions including switching elements SW1 and SW2, choke coils 520A and 520B, and diodes D1 and D2, and these conversion portions are connected in parallel, and the inductor 1 may be adopted as the choke coils 520A and 520B of each conversion portion. Describing the configuration of the DC-DC converter 500 in more detail, the DC-DC converter 500 includes a pair of input terminals A1 and A2, a pair of output terminals B1 and B2, the switching element SW1 and the choke coil 520A connected in this order in series between the input terminal A1 and the output terminal B1, the switching element SW2 and the choke coil 520B connected in this order in series between the input terminal A1 and the output terminal B1, and a capacitor C1 connected between the output terminals B1 and B2. The circuit including the switching element SW1 and the choke coil 520A and the circuit including the switching element SW2 and the choke coil 520B are connected in parallel between the input terminal A1 and the output terminal B1. The input terminal A2 and the output terminal B2 configure a ground line. The diode D2 is connected in the reverse direction between a connection point of the switching element SW1 and the choke coil 520A and the ground line, and the diode D1 is connected in the reverse direction between a connection point of the switching element SW2 and the choke coil 520B and the ground line. The switching elements SW1 and SW2 are alternately turned on and off by a control circuit (not illustrated), and thus an output voltage obtained by stepping down an input voltage is generated. By configuring the pair of choke coils 520A and 520B in the DC-DC converter 500 with the pair of coil conductors 3A and 3B of the inductor 1, the number of components configuring the DC-DC converter 500 can be reduced.

As illustrated in FIG. 2, the magnetic body 2A has principal surfaces 2Aa and 2Ab, end surfaces 2Ac and 2Ad, and side surfaces 2Ae and 2Af. The principal surfaces 2Aa and 2Ab are surfaces opposed to each other in the X-axis direction. The principal surface 2Aa is disposed on the positive side in the X-axis direction, and the principal surface 2Ab is disposed on the negative side in the X-axis direction. The end surfaces 2Ac and 2Ad are surfaces opposed to each other in the Y-axis direction. The end surface 2Ac is disposed on the positive side in the Y-axis direction, and the end surface 2Ad is disposed on the negative side in the Y-axis direction. The side surfaces 2Ae and 2Af are surfaces opposed to each other in the Z-axis direction. The side surface 2Ae is disposed on the positive side in the Z-axis direction, and the side surface 2Af is disposed on the negative side in the Z-axis direction.

The magnetic body 2B has principal surfaces 2Ba and 2Bb, end surfaces 2Bc and 2Bd, and side surfaces 2Be and 2Bf. The magnetic body 2C has principal surfaces 2Ca and 2Cb, end surfaces 2Cc and 2Cd, and side surfaces 2Ce and 2Cf. These surfaces have configurations similar to the principal surfaces 2Aa and 2Ab, the end surfaces 2Ac and 2Ad, and the side surfaces 2Ae and 2Af of the magnetic body 2A.

The principal surface 2Ab of the magnetic body 2A and the principal surface 2Ba of the magnetic body 2B are disposed to face each other in a state of being separated from each other in the X-axis direction. The principal surface 2Bb of the magnetic body 2B and the principal surface 2Ca of the magnetic body 2C are disposed to face each other in a state of being separated from each other in the X-axis direction. As a result, the magnetic body 2A is disposed to sandwich a portion (region 17A) located between conductor portions 11A and 12A that will be described later with the magnetic body 2B in the X-axis direction. The magnetic body 2C is disposed to sandwich a portion (region 17B) located between conductor portions 11B and 12B described later with the magnetic body 2B in the X-axis direction. In the present embodiment, the end surfaces 2Ac and 2Ad, the end surfaces 2Bc and 2Bd, and the end surfaces 2Cc and 2Cd are disposed at the same position in the Y-Z plane to overlap each other when viewed from the X-axis direction. Therefore, the magnetic bodies 2A, 2B, and 2C may have the same area as viewed from the X-axis direction. In addition, the thicknesses of the magnetic bodies 2A, 2B, and 2C in the X-axis direction may be the same. That is, the magnetic bodies 2A, 2B, and 2C may have the same size. Note that, in the present specification, “same position” includes a positional deviation within a range caused by a manufacturing error or the like, and “same” and “same size” include an error within a range caused by a manufacturing variation.

The coil conductor 3A includes a conductor portion 11A (second conductor), a conductor portion 12A (third conductor), a coupling portion 13A (fourth conductor), a terminal portion 14A (first conductor), and a terminal portion 16A (fifth conductor). The material of the coil conductor 3A includes a metal selected from, for example, Cu, Ag, Au, Al, Ni, and Sn.

The conductor portions 11A and 12A extend in the Z-axis direction and are disposed between the magnetic body 2A and the magnetic body 2B in the X-axis direction. The conductor portion 11A is disposed on the positive side in the Y-axis direction, and the conductor portion 12A is disposed on the negative side in the Y-axis direction. The coupling portion 13A is a member that couples the conductor portion 11A and the conductor portion 12A. The coupling portion 13A is connected to the end portions of the conductor portions 11A and 12A on the positive side in the Z-axis direction and extends in the Y-axis direction. The terminal portion 14A is provided at the end portion of the conductor portion 11A on the negative side in the Z-axis direction, and extends to the positive side in the X-axis direction and the positive side in the Y-axis direction. The terminal portion 14A is configured by forming a part of the vicinity of the end portion of the conductor portion 11A on the negative side in the Z-axis direction to be wide toward the positive side in the Y direction and bending the wide portion toward the positive side in the X direction. The terminal portion 16A is provided at the end portion of the conductor portion 12A on the negative side in the Z-axis direction, and extends to the positive side in the X-axis direction and the negative side in the Y-axis direction. The terminal portion 16A is configured by forming a part of the vicinity of the end portion of the conductor portion 12A on the negative side in the Z-axis direction to be wide toward the negative side in the Y direction and bending the wide portion toward the positive side in the X direction. The terminal portions 14A and 16A are bonded to the electrodes 102 (see FIG. 1) of the substrate 101. As a result, the inductor 1 is mounted on the substrate 101. The conductor portions 11A and 12A need not be parallel to the Z-axis direction as long as the conductor portions 11A and 12A extend in the Z-axis direction. The coupling portion 13A need not be parallel to the Y-axis direction as long as the coupling portion 13A extends in the Y-axis direction.

The coil conductor 3A has a side surface 3Aa on the positive side in the X-axis direction and a side surface 3Ab on the negative side in the X-axis direction. The side surface 3Aa is formed by disposing the side surfaces of the conductor portions 11A and 12A and the coupling portion 13A on the positive side in the X-axis direction on the same plane. The terminal portions 14A and 16A protrude further toward the positive side in the X-axis direction than the side surface 3Aa. The side surface 3Aa faces the principal surface 2Ab of the magnetic body 2A in the X-axis direction and is in contact with the principal surface 2Ab. The side surface 3Ab is formed by arranging the conductor portions 11A and 12A and the side surface on the negative side in the X-axis direction of the coupling portion 13A on the same surface. The side surface 3Ab faces the principal surface 2Ba of the magnetic body 2B in the X-axis direction and is in contact with the principal surface 2Ba. Since the magnetic bodies 2A, 2B, and 2C and the coil conductors 3A and 3B are disposed in contact with each other, a positional relationship among the magnetic bodies 2A, 2B, and 2C particularly in the X-axis direction is stabilized, so that a variation in inductance can be reduced. In the present specification, “contact” includes not only a case where the magnetic bodies 2A and 2B are in direct contact with the coil conductor 3A but also a case where the magnetic bodies 2A and 2B are in indirect contact with the coil conductor 3A via an insulating layer, an adhesive layer, or the like. The same applies to contact between the magnetic bodies 2B and 2C that will be described later and the coil conductor 3B.

As illustrated in FIG. 2, the coil conductor 3B includes a conductor portion 11B (second conductor), a conductor portion 12B (third conductor), a coupling portion 13B (fourth conductor), a terminal portion 14B (first conductor), and a terminal portion 16B (fifth conductor). A material of the coil conductor 3B may be similar to that of the coil conductor 3A.

The conductor portions 11B and 12B extend in the Z-axis direction and are disposed between the magnetic body 2B and the magnetic body 2C in the X-axis direction. The conductor portion 11B is disposed on the positive side in the Y-axis direction, and the conductor portion 12B is disposed on the negative side in the Y-axis direction. The coupling portion 13B is a member that couples the conductor portion 11B and the conductor portion 12B. The coupling portion 13B is connected to the end portions of the conductor portions 11B and 12B on the positive side in the Z-axis direction and extends in the Y-axis direction. The terminal portion 14B is provided at the end portion of the conductor portion 11B on the negative side in the Z-axis direction, and extends to the negative side in the X-axis direction and the positive side in the Y-axis direction. The terminal portion 14B is configured by forming a part in the vicinity of the negative end portion of the conductor portion 11B in the Z-axis direction to be wide toward the positive side in the Y-axis direction and bending the wide portion toward the negative side in the X-axis direction. The terminal portion 16B is provided at the end portion of the conductor portion 12B on the negative side in the Z-axis direction, and extends to the negative side in the X-axis direction and the negative side in the Y-axis direction. The terminal portion 16B is configured by forming a part in the vicinity of the end portion of the conductor portion 12B on the negative side in the Z-axis direction to be wide toward the negative side in the Y-axis direction and bending the wide portion toward the negative side in the X-axis direction. The terminal portions 14B and 16B are bonded to the electrodes 102 (see FIG. 1) of the substrate 101. As a result, the inductor 1 is mounted on the substrate 101. Note that the conductor portions 11B and 12B need not be parallel to the Z-axis direction as long as the conductor portions 11B and 12B extend in the Z-axis direction. The coupling portion 13B need not be parallel to the Y-axis direction as long as the coupling portion 13B extends in the Y-axis direction.

The coil conductor 3B has a side surface 3Ba on the positive side in the X-axis direction and a side surface 3Bb on the negative side in the X-axis direction. The side surface 3Ba is formed by disposing the side surfaces of the conductor portions 11B and 12B and the coupling portion 13B on the positive side in the X-axis direction on the same plane. The side surface 3Ba faces the principal surface 2Bb of the magnetic body 2B in the X-axis direction and is in contact with the principal surface 2Bb. The side surface 3Bb is formed by disposing the side surfaces of the conductor portions 11B and 12B and the coupling portion 13B on the negative side in the X-axis direction on the same plane. The terminal portions 14B and 16B protrude further toward the negative side in the X-axis direction than the side surface 3Bb. The side surface 3Bb faces the principal surface 2Ca of the magnetic body 2C in the X-axis direction and is in contact with the principal surface 2Ca.

The coil conductor 3A and the coil conductor 3B have a plane-symmetrical structure with respect to the ZY plane. Therefore, when viewed from the X-axis direction, the coil conductor 3A and the coil conductor 3B are formed in the same shape to overlap each other. Note that “plane symmetry” includes a positional deviation within a range caused by a manufacturing error or the like, and the “same shape” includes an error within a range caused by a manufacturing variation.

The resin member 6A is disposed to cover the side surface 2Af of the magnetic body 2A on the negative side in the Z-axis direction. The resin member 6B is disposed to cover the side surface 2Bf of the magnetic body 2B on the negative side in the Z-axis direction. The resin member 6C is disposed to cover the side surface 2Cf of the magnetic body 2C on the negative side in the Z-axis direction. The resin members 6A, 6B, and 6C are sheet-like members that cover substantially the entire surfaces of the side surfaces 2Af, 2Bf, and 2Cf. A material of the resin members 6A, 6B, and 6C is not particularly limited, and polyimide, polyamideimide, fluororesin, or the like may be adopted. As the resin members 6A, 6B, and 6C, for example, Kapton (registered trademark) tape may be adopted.

The side surfaces 2Af and 2Cf (surfaces on the other side) of the magnetic bodies 2A and 2C on the negative side in the Z-axis direction are placed on upper surfaces 14a and 16a of the terminal portions 14A, 16A 14B, and 16B via the resin members 6A and 6C. As a result, the resin member 6A is disposed between the magnetic body 2A and the terminal portions 14A and 16A. The resin member 6C is disposed between the magnetic body 2C and the terminal portions 14B and 16B. In the present embodiment, the side surface 2Bf of the magnetic body 2B on the negative side in the Z-axis direction is disposed at the same height as the side surfaces 2Af and 2Cf of the other magnetic bodies 2A and 2C on the negative side in the Z-axis direction. Note that the “same height” includes an error within a range caused by a manufacturing variation.

Next, the resin material 5 will be described. The resin material 5 covers the assembly of the magnetic bodies 2A, 2B, and 2C and the coil conductors 3A and 3B. The resin material 5 exposes at least the lower surfaces of the terminal portions 14A, 16A, 14B, and 16B. Therefore, the resin material 5 covers at least the side surfaces 2Ae, 2Be, and 2Ce of the magnetic bodies 2A, 2B, and 2C on the positive side in the Z-axis direction. The resin material 5 may contain a magnetic powder. Specifically, a thermosetting resin such as epoxy is adopted as a material of the resin material 5. In a case where the resin material 5 contains a magnetic powder, a mixture of a soft magnetic metal powder and a resin or the like may be adopted. As the soft magnetic metal powder, an iron-silicon alloy, permalloy, sendust, amorphous, nanocrystalline alloy, or a mixture thereof may be used. In a case where the resin material 5 contains a magnetic powder, the magnetic permeability of the resin material 5 may be 5 or more, or 20 or more. The magnetic permeability of the resin material 5 may be 100 or less, and may be 50 or less. The resin material 5 may have a magnetic permeability lower than that of the magnetic bodies 2A, 2B, and 2C. The resin material 5 is disposed in the regions 17A and 17B. That is, the resin material 5 is formed to cover the inner portions 11Aa, 11Ba, 12Aa, 12Ba, 13Aa, and 13Ba.

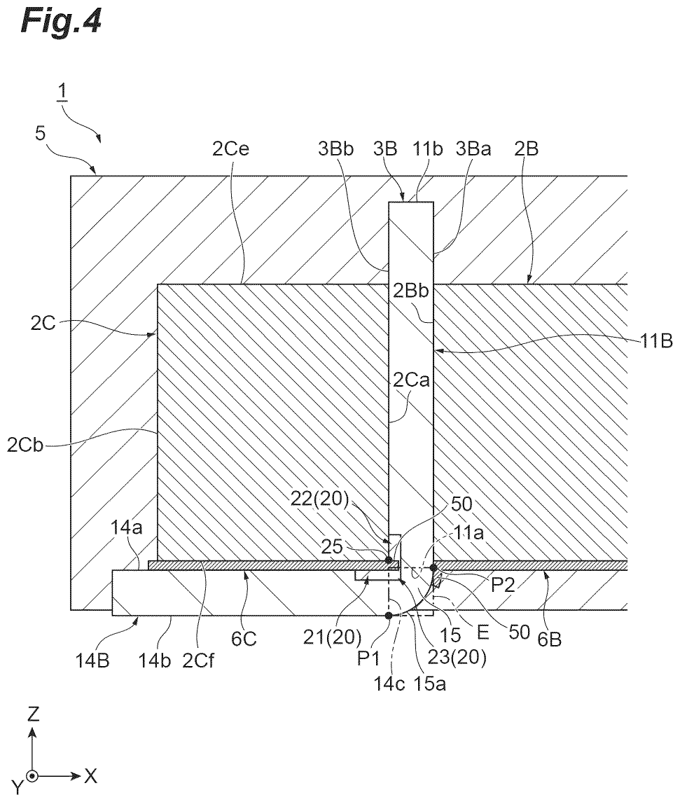

Next, a structure near the side surface 2Cf of the magnetic body 2C on the negative side in the Z-axis direction will be described in detail with reference to FIG. 4. FIG. 4 is a cross-sectional view taken along line IV-IV illustrated in FIG. 1. FIGS. 1 and 2 are schematic configuration diagrams, and the thicknesses of the magnetic bodies 2A, 2B, and 2C in the X-axis direction are drawn to be small. However, as illustrated in FIG. 4, the thickness in the X-axis direction may be increased.

In the portion illustrated in FIG. 4, the coil conductor 3B includes a connection conductor 15. The connection conductor 15 is a portion that connects one end portion 11a of the conductor portion 11B (on the negative side in the Z-axis direction) and one end portion 14c of the terminal portion 14B (on the positive side in the X-axis direction). In the structure near the corner portion between the terminal portion 14B and the conductor portion 11B, there is a switching portion P1 that switches from a state in which the outer side (lower surface 14b side) of the terminal portion 14B extends in the X-axis direction to a state of extending in the Z-axis direction. In addition, there is a switching portion P2 that switches from a state in which the outer side (side surface 3Ba side) of the conductor portion 11B extends in the Z-axis direction to a state of extending in the X-axis direction. The connection conductor 15 is a portion existing between these switching portions P1 and P2. In FIG. 4, a pair of two-dot chain lines is drawn by extending the surfaces 14a and 14b of the terminal portion 14B to the positive side in the X-axis direction, and a pair of two-dot chain lines is drawn by extending the surfaces 3Ba and 3Bb of the conductor portion 11B to the negative side in the Z-axis direction. A region set by these four two-dot chain lines is defined as a region E. A portion of the coil conductor 3B existing in the region E corresponds to the connection conductor 15. The outer side of the connection conductor 15 has a curved shape 15a. The curved shape 15a draws an arc bulging outward with a predetermined curvature radius between the switching portions P1 and P2. In a case where the surfaces of the conductor portion 11A and the terminal portion 14B are the minimum wavy surfaces or uneven surfaces, a two-dot chain line extending from the surface of the terminal portion 14B to the positive side in the X-axis direction and a two-dot chain line extending from the surface of the conductor portion 11A to the negative side in the Z-axis direction may be regression lines (linear approximation).

The magnetic body 2C has a corner portion 25 between the principal surface 2Ca on the positive side in the X-axis direction and the side surface 2Cf on the negative side in the Z-axis direction. As described above, the principal surface 2Ca of the magnetic body 2C is in contact with the side surface 3Bb of the conductor portion 11B. The side surface 2Cf of the magnetic body 2C is in contact with the upper surface 14a of the terminal portion 14B via the resin member 6C. With such a positional relationship, the corner portion 25 of the magnetic body 2C is disposed to face the connection conductor 15 of the coil conductor 3B. The corner portion 25 of the magnetic body 2C and the connection conductor 15 of the coil conductor 3B face each other in an oblique direction including a direction component in the X-axis direction and a direction component in the Z-axis direction.

The terminal portion 14B has a first recessed portion 21 recessed from the inside to the outside at a position adjacent to the connection conductor 15. The first recessed portion 21 is recessed toward the negative side in the Z-axis direction from the upper surface 14a which is the inner surface of the terminal portion 14B. The end portion 14c on the positive side in the X-axis direction is located at a position adjacent to the connection conductor 15 on the negative side in the X-axis direction. Therefore, the terminal portion 14B has the first recessed portion 21 at least at the position of the end portion 14c. Note that the position adjacent to the connection conductor 15 includes a position slightly away from the connection conductor 15 (for example, within a range of a manufacturing error or the like).

The conductor portion 11B has a first recessed portion 22 recessed from the inside to the outside at a position adjacent to the connection conductor 15. The first recessed portion 22 is recessed toward the positive side in the X-axis direction from the side surface 3Bb which is the inner surface of the conductor portion 11B. The end portion 11a on the negative side in the Z-axis direction is located at a position adjacent to the connection conductor 15 on the positive side in the Z-axis direction. Therefore, the conductor portion 11B has the first recessed portion 22 at least at the position of the end portion 11a.

As described above, in the present embodiment, the terminal portion 14B and the conductor portion 11B respectively include the first recessed portions 21 and 22 recessed from the inside to the outside at positions adjacent to the connection conductor 15. In addition, in the present embodiment, the connection conductor 15 has a second recessed portion 23 recessed from the inside to the outside. The second recessed portion 23 is recessed from the position of the end portion 14c of the terminal portion 14B toward the positive side in the X-axis direction, and is recessed from the position of the end portion 11a of the conductor portion 11B toward the negative side in the Z-axis direction. The second recessed portion 23 of the connection conductor 15 communicates with the first recessed portions 21 and 22. Note that, in the following description, the term “recessed portion 20” indicates a combination of the recessed portions 21, 22, and 23. In the present embodiment, the coil conductor 3B has the recessed portion 20 having an L-shaped cross section. A method of forming the recessed portion 20 is not particularly limited, and a known method of providing a recessed portion in a conductor may be adopted.

The resin member 6C may have a burr 50 (a part of the resin member) formed at the time of cutting or the like. The burr 50 protrudes toward the positive side in the X-axis direction from the principal surface 2Ca of the magnetic body 2C. Such a burr 50 is accommodated in the recessed portion 20 of the coil conductor 3B. In particular, the burr 50 may be accommodated in the first recessed portion 22 that is recessed toward the positive side in the X-axis direction without being bent. Further, the burr 50 may be bent and accommodated in the second recessed portion 23. Further, the burr 50 may be bent (folded) and accommodated in the first recessed portion 21 recessed to the negative side in the Z-axis direction. Further, depending on a shape of the burr 50, the burr may be accommodated in a plurality of recessed portions 21, 22, and 23. A shape of the burr 50 may not be constant in the Y-axis direction, and the recessed portions 21, 22, and 23 in which the burr is accommodated may be different depending on locations in the Y-axis direction. The burr 50 of the resin member 6B protrudes further toward the negative side in the X-axis direction than the principal surface 2Bb of the magnetic body 2B. The burr 50 of the resin member 6B is deformed to be bent toward the negative side in the Z-axis direction along the curved shape 15a on the outer side of the connection conductor 15.

Next, dimensions of each portion of the recessed portion 20 will be described. A length dimension of the first recessed portion 22 of the conductor portion 11B in the Z-axis direction may be larger than a thickness (a dimension in the Z-axis direction) of the resin member 6C. In addition, the length dimension of the first recessed portion 22 of the conductor portion 11B in the Z-axis direction may be smaller than a curvature radius of the curved shape 15a of the outer side of the connection conductor 15. Further, the length dimension of the first recessed portion 22 of the conductor portion 11B in the Z-axis direction may be smaller than half of a length dimension of the conductor portion 11B in the Z-axis direction. A depth (a dimension in the X-axis direction) of the first recessed portion 22 of the conductor portion 11B may be smaller than half of the thickness dimension (a dimension in the X-axis direction) of the conductor portion 11B. The depth (a dimension in the X-axis direction) of the first recessed portion 22 of the conductor portion 11B may be larger than a length dimension (a dimension in the X-axis direction) of the burr 50. Since the length dimension of the burr 50 is a value that can be predicted at the design stage, the depth of the first recessed portion 22 may be set on the basis of the value.

A length dimension of the first recessed portion 21 of the terminal portion 14B in the X-axis direction may be larger than the thickness (a dimension in the Z-axis direction) of the resin member 6C. Further, the length dimension of the first recessed portion 21 of the terminal portion 14B in the X-axis direction may be smaller than the curvature radius of the curved shape 15a of the outer side of the connection conductor 15. Further, the length dimension of the first recessed portion 21 of the terminal portion 14B in the X-axis direction may be smaller than half of a length dimension of the terminal portion 14B in the X-axis direction. A depth (a dimension in the Z-axis direction) of the first recessed portion 21 of the terminal portion 14B may be smaller than half of the thickness dimension (a dimension in the Z-axis direction) of the terminal portion 14B. Further, the depth of the first recessed portion 21 of the terminal portion 14B may be smaller than half of the thickness dimension of the terminal portion 14B in the Z-axis direction.

The dimension of the second recessed portion 23 of the connection conductor 15 in the Z-axis direction may be set to a dimension similar to the depth of the first recessed portion 21 of the terminal portion 14B in the Z-axis direction. The dimension of the second recessed portion 23 of the connection conductor 15 in the X-axis direction may be set to a dimension similar to the depth of the first recessed portion 22 of the conductor portion 11B in the X-axis direction. The inner curvature radius of the connection conductor 15 may be smaller than the thickness of the resin member 6C. In the present embodiment, since the connection conductor 15 has the second recessed portion 23, a corner R of the second recessed portion 23 is an inner curvature radius. In the example illustrated in FIG. 4, since the second recessed portion 23 does not have the corner R and is substantially a right angle, the inner curvature radius is smaller than the thickness of the resin member 6C.

The dimensions of the first recessed portions 21 and 22 in the Y-axis direction (third direction) are equal to or larger than the dimension in the Y-axis direction of the conductor having the shorter dimension in the Y-axis direction, of the conductor portion 11B and the terminal portion 14B. In the present embodiment, the dimension of the conductor portion 11B in the Y-axis direction is smaller than the dimension of the terminal portion 14B in the Y-axis direction. Therefore, the dimensions of the first recessed portions 21 and 22 in the Y-axis direction may be equal to or larger than the dimension of the shorter conductor portion 11B in the Y-axis direction. In the present embodiment, the first recessed portion 21 may extend from one end portion 14d (see FIG. 2) of the terminal portion 14B to the other end portion 14e (see FIG. 2) in the Y-axis direction (third direction). In this case, the dimension of the first recessed portion 21 in the Y-axis direction is larger than the dimension of the shorter conductor portion 11B in the Y-axis direction. However, the dimension of the first recessed portion 21 in the Y-axis direction may be equal to the dimension of the shorter conductor portion 11B in the Y-axis direction. In this case, the first recessed portion 21 may be formed in a region CE illustrated in FIG. 2. That is, the first recessed portion 21 extends from a position corresponding to one end portion 11Ba (see FIG. 2) of the conductor portion 11B to a position corresponding to the other end portion 11Bb (see FIG. 2) in the Y-axis direction. The first recessed portion 22 may extend from one end portion 11Ba (see FIG. 2) of the conductor portion 11B to the other end portion 11Bb (see FIG. 2) in the Y-axis direction.

The size of the connection conductor 15 in the Y-axis direction is determined depending on a size of a portion where the terminal portion 14B and the conductor portion 11B overlap each other in the Y-axis direction. In the example illustrated in FIG. 2, the conductor portion 11B is connected to the terminal portion 14B in the entire width direction. Therefore, the second recessed portion 23 of the connection conductor 15 may extend from one end portion 11Ba (see FIG. 2) of the conductor portion 11B to the other end portion 11Bb (see FIG. 2) in the Y-axis direction.

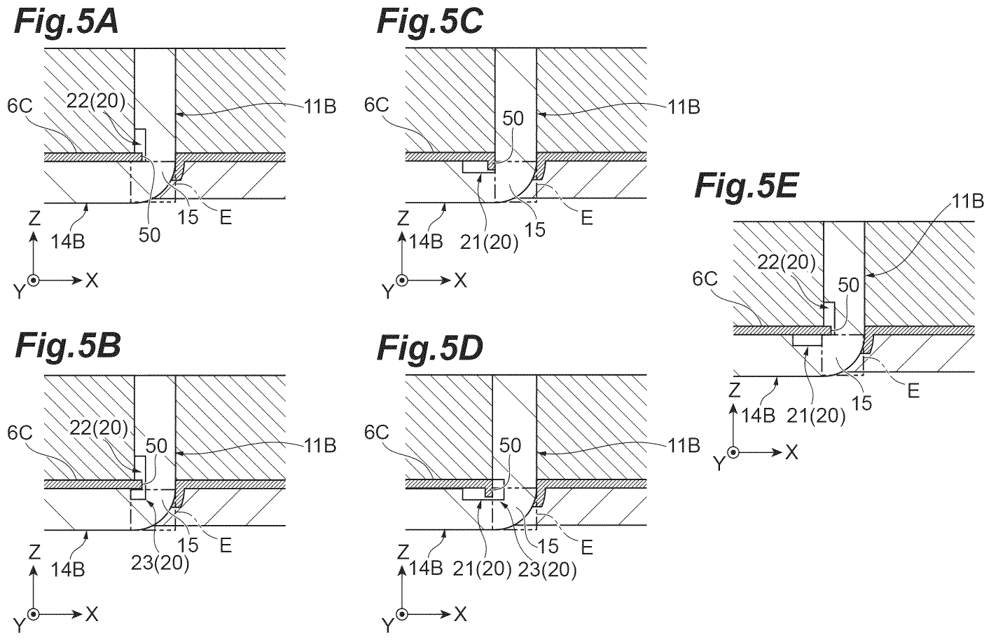

Here, the recessed portion 20 is not limited to the structure illustrated in FIG. 4. At least one conductor of the terminal portion 14B and the conductor portion 11B may have a first recessed portion recessed from the inside to the outside at a position adjacent to the connection conductor 15. For example, each of configurations as illustrated in FIGS. 5A to 5E may be adopted. As illustrated in FIG. 5A, the recessed portion 20 may have only the first recessed portion 22 of the conductor portion 11B. As illustrated in FIG. 5B, the recessed portion 20 may have the first recessed portion 22 of the conductor portion 11B and the second recessed portion 23 of the connection conductor 15 communicating with the first recessed portion 22. As illustrated in FIG. 5C, the recessed portion 20 may have only the first recessed portion 21 of the terminal portion 14B. As illustrated in FIG. 5D, the recessed portion 20 may have the first recessed portion 21 of the terminal portion 14B and the second recessed portion 23 of the connection conductor 15 communicating with the first recessed portion 21. As illustrated in FIG. 5E, the recessed portion 20 may have a first recessed portion 22 of the conductor portion 11B and a first recessed portion 21 of the terminal portion 14B. In the forms illustrated in FIGS. 5A, 5B, and 5E, the burr 50 may be accommodated in the first recessed portion 22 that is recessed toward the positive side in the X-axis direction without being bent. In the forms illustrated in FIGS. 5C and 5D, the burr 50 may be bent toward the negative side in the Z-axis direction and accommodated in the first recessed portion 21 that is recessed toward the negative side in the Z-axis direction.

As illustrated in FIG. 2, the coil conductor 3B includes the terminal portion 16B and the conductor portion 12B on the negative side in the Y-axis direction. The coil conductor 3B may have the recessed portion 20 similar to that in FIG. 4 near the connection conductor connecting the terminal portion 16B and the conductor portion 12B. The magnetic body 2C is placed on the terminal portion 14B and the terminal portion 16B via the resin member 6C. In this case, the burr 50 (see FIG. 4) of the resin member 6C provided on the magnetic body 2C is accommodated in the recessed portion 20 of the terminal portion 14B and the conductor portion 11B and the recessed portion 20 of the terminal portion 16B and the conductor portion 12B. In addition, the coil conductor 3A may have the recessed portion 20 similar to that in FIG. 4 near the connection conductor connecting the terminal portion 14A and the conductor portion 11A, and may have the recessed portion 20 similar to that in FIG. 4 near the connection conductor connecting the terminal portion 16A and the conductor portion 12A.

In the coil conductor 3B, in a case where the terminal portion 14B is regarded as a “first conductor” in the claims, the conductor portion 11B may be regarded as a “second conductor”, the conductor portion 12B may be regarded as a “third conductor”, the coupling portion 13B may be regarded as a “fourth conductor”, and the terminal portion 16B may be regarded as a “fifth conductor”. In the coil conductor 3B, in a case where the terminal portion 16B is regarded as a “first conductor” in the claims, the conductor portion 12B may be regarded as a “second conductor”, the conductor portion 11B may be regarded as a “third conductor”, the coupling portion 13B may be regarded as a “fourth conductor”, and the terminal portion 14B may be regarded as a “fifth conductor”. In the coil conductor 3A, in a case where the terminal portion 14A is regarded as a “first conductor” in the claims, the conductor portion 11A may be regarded as a “second conductor”, the conductor portion 12A may be regarded as a “third conductor”, the coupling portion 13A may be regarded as a “fourth conductor”, and the terminal portion 16A may be regarded as a “fifth conductor”. In the coil conductor 3A, in a case where the terminal portion 16A is regarded as a “first conductor” in the claims, the conductor portion 12A may be regarded as a “second conductor”, the conductor portion 11A may be regarded as a “third conductor”, the coupling portion 13A may be regarded as a “fourth conductor”, and the terminal portion 14A may be regarded as a “fifth conductor”.

Next, functions and effects of the inductor 1 and the DC-DC converter 100 according to the present embodiment will be described. Note that, unless otherwise noted, functions and effects of the inductor 1 according to the present embodiment in the structure near the connection conductor 15 connecting the terminal portion 14B and the conductor portion 11B will be described with reference to FIG. 4. However, similar functions and effects can be achieved for the structure near the connection conductor 15 in other portions.

In the inductor 1 according to the present embodiment, the corner portion 25 of the magnetic body 2C is disposed to face the connection conductor 15 of the coil conductor 3B. In addition, the inductor 1 includes the resin member 6C disposed between the magnetic body 2C and the terminal portion 14B of the coil conductor 3B. Therefore, the magnetic body 2C is disposed on the terminal portion 14B in a state of being insulated from the terminal portion 14B, and is disposed in a state of being positioned in the X-axis direction with respect to the conductor portion 11.

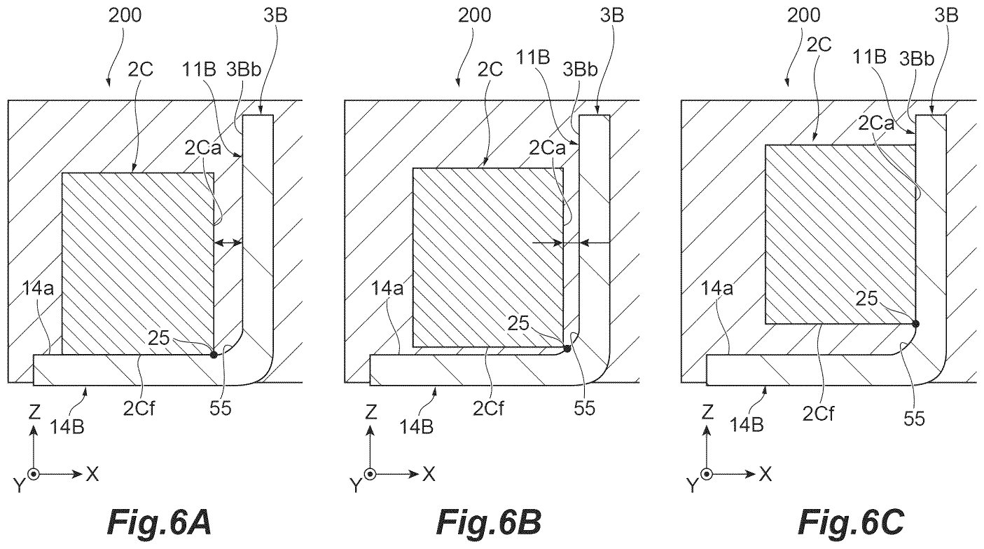

Here, an inductor 200 according to a comparative example will be described with reference to FIGS. 6A to 6C. The inductor 200 illustrated in FIGS. 6A to 6C has a curved shape 55 due to a corner R between the conductor portion 11B and the terminal portion 14B. In this case, as illustrated in FIG. 6A, when the side surface 2Cf of the magnetic body 2C is brought into contact with the upper surface 14a of the terminal portion 14B, the corner portion 25 of the magnetic body 2C and the curved shape 55 interfere with each other. As a result, a gap is formed between the magnetic body 2C and the side surface 3Bb of the conductor portion 11B. As illustrated in FIG. 6B, when the magnetic body 2C is brought close to the conductor portion 11B, the corner portion 25 rides on the curved shape 55. As illustrated in FIG. 6C, when the principal surface 2Ca of the magnetic body 2C is brought into contact with the conductor portion 11, a gap is formed between the side surface 2Cf of the magnetic body 2C and the upper surface 14a of the terminal portion 14B.

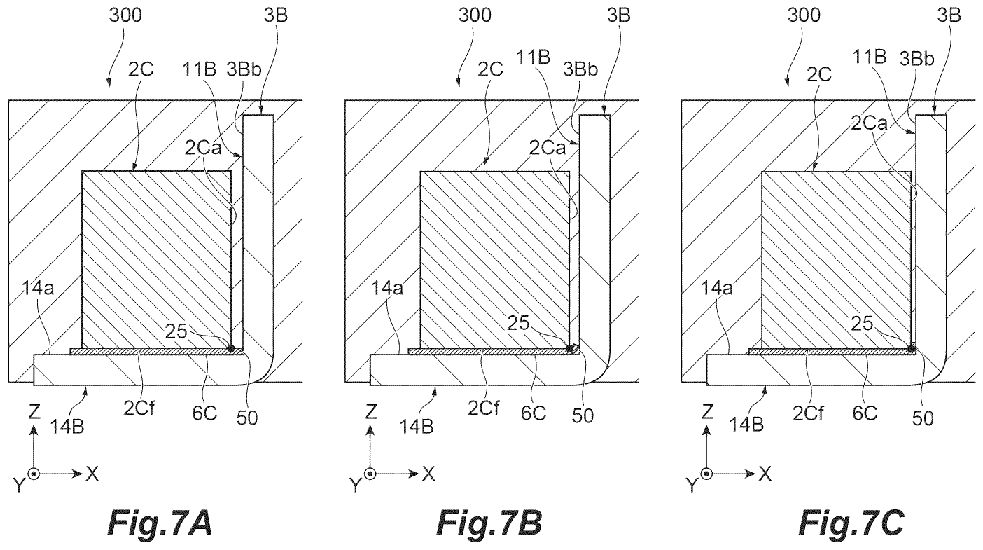

An inductor 300 according to another comparative example will be described with reference to FIGS. 7A to 7C. In the inductor 300 illustrated in FIGS. 7A to 7C, the corner R is not formed between the conductor portion 11B and the terminal portion 14B, and the side surface 3Bb rises substantially vertically from the upper surface 14a. In this case, as illustrated in FIGS. 7A, 7B, and 7C, the burr 50 of the resin member 6C is interposed between the principal surface 2Ca of the magnetic body 2C and the side surface 3Bb of the conductor portion 11B, and a gap is formed. In this case, a distance between the principal surface 2Ca of the magnetic body 2C and the side surface 3Bb of the conductor portion 11B changes depending on a size or the degree of crushing of the burr 50. The closer the magnetic body 2C and the conductor portion 11B are, the larger the inductance is, and the farther the magnetic body 2C and the conductor portion 11B are, the smaller the inductance is. As described above, the inductors 200 and 300 according to the comparative examples has a problem that magnetic characteristics is unstable due to the occurrence of a positional deviation between the magnetic body 2C and the conductor portion 11B.

In contrast, in the inductor 1 according to the present embodiment, the terminal portion 14B and the conductor portion 11B have the first recessed portions 21 and 22 recessed from the inside to the outside at positions adjacent to the connection conductor 15. The dimensions of the first recessed portions 21 and 22 in the Y-axis direction (third direction) are equal to or larger than the dimension in the Y-axis direction of the shorter conductor (here, the conductor portion 11B) in the Y-axis direction, of the conductor portion 11B and the terminal portion 14B. Therefore, even in a case where the burr 50 is generated in the resin member 6C, the burr 50 can be accommodated in at least one of the first recessed portions 21 and 22. In this case, the principal surface 2Ca of the magnetic body 2C can be stably brought into contact with the side surface 3Bb of the conductor portion 11B. Therefore, a positional deviation of the magnetic body 2C with respect to the conductor portion 11B can be suppressed. As described above, stable magnetic characteristics can be obtained. In a case where the burr 50 is not generated in the resin member 6C, a part of the resin member 6C need not be accommodated in the first recessed portions 21 and 22.

At least a part (burr 50) of the resin member 6C may be accommodated in either one of the first recessed portions 21 and 22. In this case, as described above, the principal surface 2Ca of the magnetic body 2C can be stably brought into contact with the side surface 3Bb of the conductor portion 11B. Therefore, a positional deviation of the magnetic body 2C with respect to the conductor portion 11B can be suppressed.

The terminal portion 14B (first conductor) and the conductor portion 11B (second conductor) may respectively have the first recessed portions 21 and 22 recessed from the inside to the outside at positions adjacent to the connection conductor 15. Since both the first recessed portions 21 and 22 are provided, the burr 50 can be accommodated in either the first recessed portion 21 or the first recessed portion 22 regardless of a deformation form of the burr 50. As described above, the burr 50 can be easily accommodated.

The connection conductor 15 may have the second recessed portion 23 recessed from the inside to the outside, and the second recessed portion 23 of the connection conductor 15 may communicate with the first recessed portions 21 and 22 of at least one conductor. In this case, since the recessed portion 20 capable of accommodating the burr 50 is widened, the burr 50 can be accommodated in the recessed portion 20 in a state in which the burr 50 is suppressed from being excessively deformed. Therefore, a positional deviation between the magnetic body 2C and the conductor portion 11B can be further suppressed, and more stable magnetic characteristics can be obtained.

The length dimension of the first recessed portion 22 of the conductor portion 11B in the Z-axis direction may be larger than the thickness of the resin member 6C. In this case, it is possible to improve the reliability that the first recessed portion 22 accommodates the burr 50.

The depth of the first recessed portion 21 of the terminal portion 14B may be smaller than half of the thickness dimension of the terminal portion 14B. Further, the depth of the first recessed portion 22 of the conductor portion 11B may be smaller than half of the thickness dimension of the conductor portion 11B. In this case, an increase in electric resistance can be suppressed by suppressing a decrease in the conductor volume of the coil conductor 3B.

The inner curvature radius of the connection conductor 15 may be smaller than the thickness of the resin member 6C. In this case, it is possible to suppress interference between the corner R on the inner peripheral side of the connection conductor 15 and the burr 50. Therefore, since the magnetic body 2C can be disposed close to the conductor portion 11B, stable and high magnetic characteristics can be obtained.

The outer side of the connection conductor 15 may have the curved shape 15a, and the length dimension of the first recessed portion 22 of the conductor portion 11B in the Z-axis direction may be smaller than the curvature radius of the curved shape 15a of the connection conductor 15. In this case, an increase in electric resistance can be suppressed by suppressing a decrease in the conductor volume of the coil conductor 3B.

The outer side of the connection conductor 15 may have the curved shape 15a, and the length dimension of the first recessed portion 21 of the terminal portion 14B in the X-axis direction may be smaller than the curvature radius of the curved shape 15a of the connection conductor 15. In this case, an increase in electric resistance can be suppressed by suppressing a decrease in the conductor volume of the coil conductor 3B.

The coil conductor 3B may include the conductor portion 12B (third conductor) extending in the Z-axis direction, the coupling portion 13B (fourth conductor) coupling the other end portion 11b of the conductor portion 11B and one end portion of the conductor portion 12B, and the terminal portion 16B (fifth conductor) connected to the other end portion of the conductor portion 12B and extending in the X-axis direction, and the magnetic body 2C may be placed on the terminal portions 14B and 16B via the resin member 6. As described above, by supporting the magnetic body 2C on both sides in the Y-axis direction with the terminal portions 14B and 16B, a positional relationship between the magnetic body 2C and the coil conductor 3B can be fixed, and stable magnetic characteristics can be obtained.

The DC-DC converter 100 according to the present embodiment includes the inductor described above.

According to the DC-DC converter 100, since a variation in the inductance of the inductor 1 is small, it is possible to obtain the DC-DC converter 100 in which a variation in an output waveform is small. Since the adhesion between the resin and the magnetic bodies is high, the DC-DC converter 100 having high long-term reliability can be obtained.

The present disclosure is not limited to the above-described embodiments.

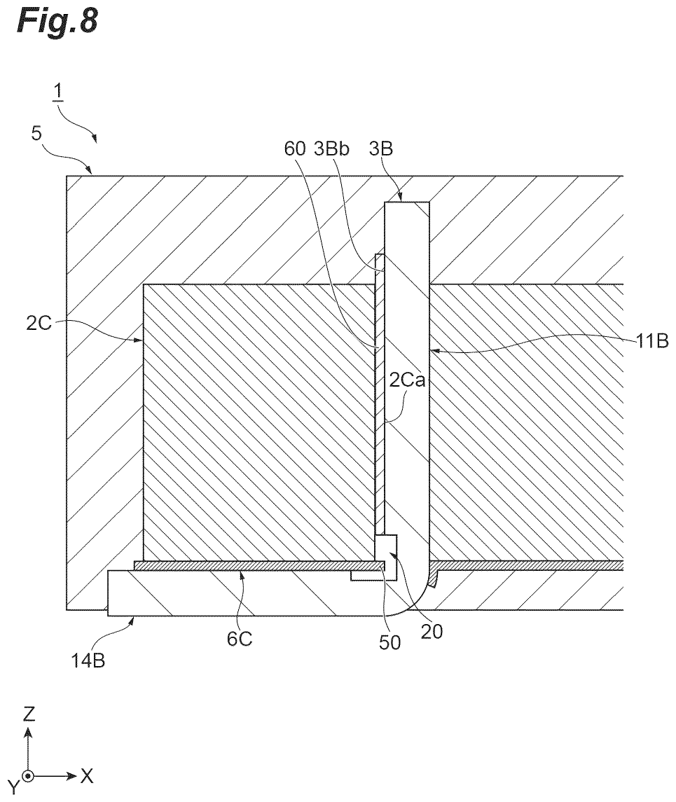

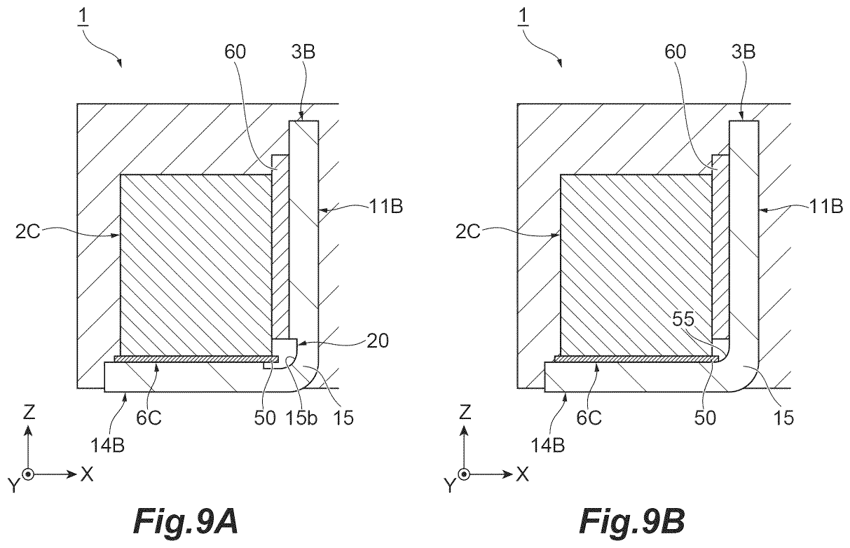

For example, the inductor 1 illustrated in FIG. 8 may be adopted. In the inductor 1 illustrated in FIG. 8, the conductor portion 11B and the magnetic body 2C may be in close contact with each other via an adhesive layer 60. In this case, the adhesive layer 60 is interposed between the principal surface 2Ca of the magnetic body 2C and the side surface 3Bb of the conductor portion 11B. Therefore, by adjusting a thickness of the adhesive layer 60, a positional deviation between the magnetic body 2C and the conductor portion 11B can be suppressed. For example, as illustrated in FIG. 9B, even in a case where the adhesive layer 60 is provided, when the recessed portion 20 is not formed, the curved shape 55 of the corner portion and the burr 50 may interfere with each other. In contrast, according to the structure illustrated in FIG. 8, the burr 50 can be accommodated in the recessed portion 20.

Here, as illustrated in FIG. 9A, in the recessed portion 20, the connection conductor 15 may have the curved shape 15b on the inner side. In this case, the curvature radius of the inner curved shape 15b of the connection conductor 15 may be smaller than the thickness of the adhesive layer 60. In this case, the burr 50 accommodated in the recessed portion 20 can be prevented from interfering with the curved shape 15b of the connection conductor 15. Therefore, since the magnetic body 2C can be disposed close to the conductor portion 11B, stable and high magnetic characteristics can be obtained.

A shape of the coil conductor is not limited to that adopted in the above-described embodiment, and may be changed as appropriate without departing from the scope of the present disclosure.

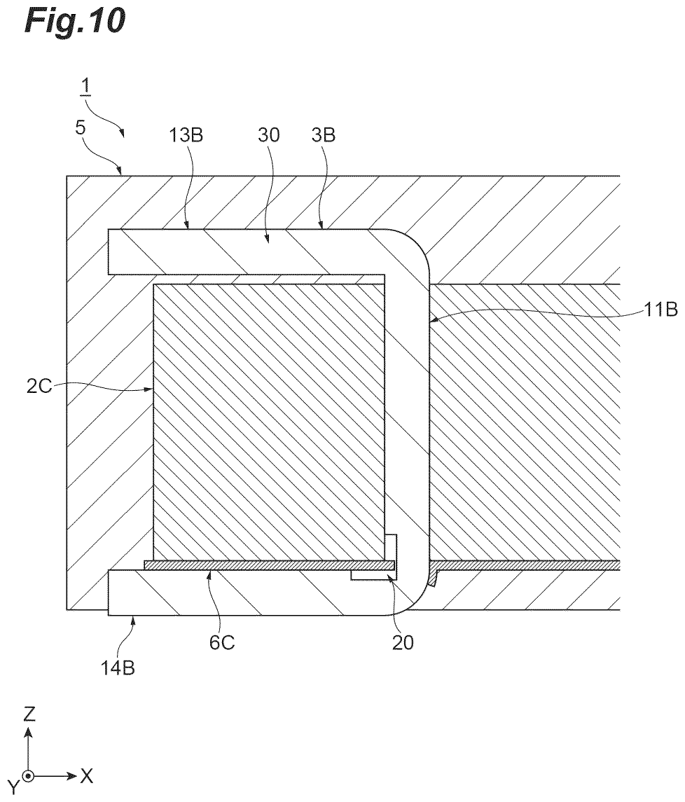

For example, a coil conductor 3B as illustrated in FIG. 10 may be adopted. In the coil conductor 3B illustrated in FIG. 10, a portion of the conductor portion 11B (and the conductor portion 12B) on the positive side in the Z-axis direction and a portion of the coupling portion 13B are defined as a bent portion 30. The bent portion 30 has a shape extending toward the negative side in the X-axis direction. In this manner, a shape of the coil conductor may be changed as appropriate.

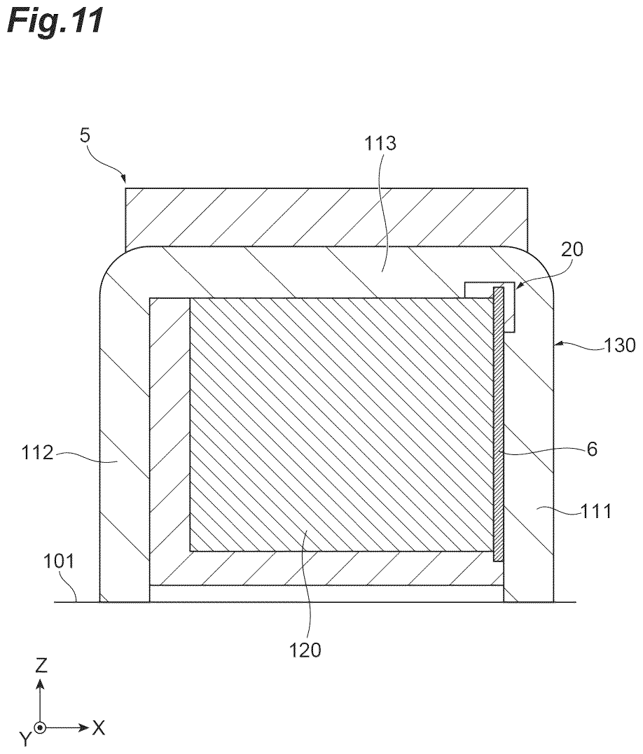

In addition, a location where the recessed portion 20 is formed may also be changed as appropriate in accordance with a change of a shape of the coil conductor. For example, a coil conductor 130 as illustrated in FIG. 11 may be adopted. The coil conductor 130 includes a pair of conductor portions 111 and 112 rising from the substrate 101 toward the positive side in the Z-axis direction, and a coupling portion 113 extending in the Y-axis direction to couple upper ends of the conductor portions 111 and 112. The magnetic body 120 is disposed such that an inner peripheral portion of the coil conductor 130 is inserted in the X-axis direction. The magnetic body 120 is in contact with the coupling portion 113 and is in contact with the conductor portion 111 via the resin member 6. In this case, the recessed portion 20 may be formed at a bent portion between the conductor portion 111 and the coupling portion 113. In this case, the conductor portion 111 corresponds to a “first conductor” in the claims, and the coupling portion 113 corresponds to a “second conductor” in the claims.

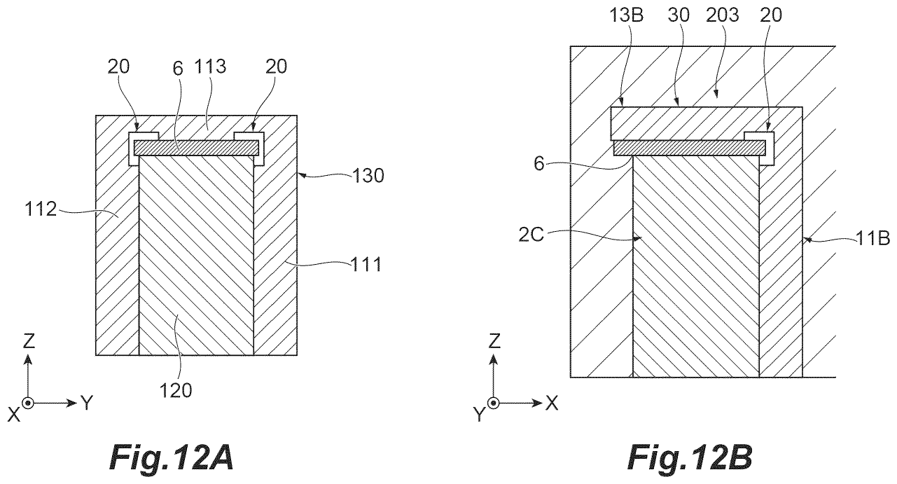

In addition, a configuration as illustrated in FIG. 12A may be adopted. In FIG. 12A, compared with the coil conductor 130 illustrated in FIG. 11, the magnetic body 120 is in contact with the coupling portion 113 via the resin member 6. The recessed portion 20 may be formed at a bent portion between the conductor portion 111 and the coupling portion 113. In addition, the recessed portion 20 may be formed at a bent portion between the conductor portion 112 and the coupling portion 113. In this case, the coupling portion 113 corresponds to a “first conductor” in the claims, and the conductor portions 111 and 112 correspond to “second conductors” in the claims.

In addition, the structure illustrated in FIG. 12B may be adopted. This coil conductor 203 has a structure in which terminal portions 14B and 16B are removed from the coil conductor 3B illustrated in FIG. 10. The magnetic body 2C is in contact with the bent portion 30 via the resin member 6. In this case, the recessed portion 20 is formed between a bent portion 30 and the conductor portion 11B. In this case, the bent portion 30 corresponds to a “first conductor” in the claims, and the conductor portion 11B corresponds to a “second conductor” in the claims.

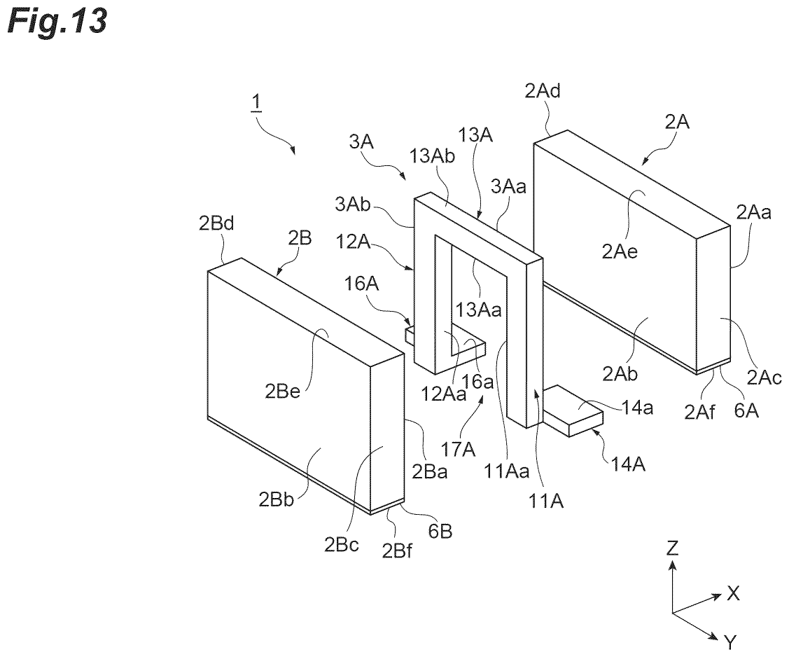

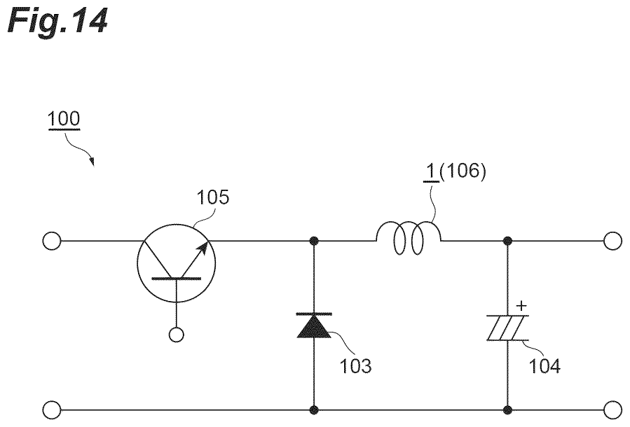

In the above-described embodiment, the inductor includes a plurality of coil conductors, but the number of coil conductors is not particularly limited, and the inductor may include one coil conductor. For example, an inductor 1 illustrated in FIG. 13 includes one coil conductor 3A and magnetic bodies 2A and 2B. Such one coil conductor 3A may be adopted in a DC-DC converter 100 illustrated in FIG. 14. As illustrated in FIG. 14, the DC-DC converter 100 includes a pair of input terminals to which a DC input voltage is input, a pair of output terminals, a switching element 105 and a choke coil 106 connected in series to a high potential side of the pair of input terminals, a diode 103 connected between a connection point between the switching element 105 and the choke coil 106 and a low potential side of the pair of input terminals, and a capacitor 104 connected between the pair of output terminals. The DC-DC converter 100 operates as a step-down converter that steps down an input DC voltage by switching on and off the switching element 105 on the basis of a control signal from a control circuit (not illustrated). Note that the DC-DC converter 100 may be a multiphase converter including a plurality of converters including the switching element 105, the choke coil 106, and the diode 103, and these converters connected in parallel, and the inductor 1 may be adopted as the choke coil 106 of each converter.

### [Aspect 1]

An inductor including:
a coil conductor including a first conductor extending in a first direction, a second conductor extending in a second direction intersecting the first direction, and a connection conductor connecting one end portion of the first conductor and one end portion of the second conductor;
a magnetic body having a corner portion and disposed such that the corner portion faces the connection conductor of the coil conductor; and
a resin member disposed between the magnetic body and the first conductor of the coil conductor, in which
at least one conductor of the first conductor and the second conductor has a first recessed portion recessed from an inside to an outside at a position adjacent to the connection conductor, and
a dimension of the first recessed portion in a third direction intersecting the first and second directions is equal to or larger than a dimension of a conductor having a shorter dimension in the third direction, of the one conductor and the other conductor, in the third direction.

### [Aspect 2]

The inductor according to Aspect 1, in which at least a part of the resin member is accommodated in the first recessed portion.

### [Aspect 3]

The inductor according to Aspect 1 or 2, in which the first conductor and the second conductor each have the first recessed portion recessed from the inside to the outside at the position adjacent to the connection conductor.

### [Aspect 4]

The inductor according to any one of Aspects 1 to 3, in which
the connection conductor has a second recessed portion recessed from the inside to the outside, and
the second recessed portion of the connection conductor communicates with the first recessed portion of the at least one conductor.

### [Aspect 5]

The inductor according to any one of Aspects 1 to 4, in which a length dimension of the first recessed portion of the second conductor in the second direction is larger than a thickness of the resin member.

### [Aspect 6]

The inductor according to any one of Aspects 1 to 5, in which a depth of the first recessed portion of the at least one conductor is smaller than half of a thickness dimension of the at least one conductor.

### [Aspect 7]

The inductor according to any one of Aspects 1 to 6, in which
the second conductor and the magnetic body are in close contact with each other via an adhesive layer, and
an inner curvature radius of the connection conductor is smaller than a thickness of the adhesive layer.

### [Aspect 8]

The inductor according to any one of Aspects 1 to 7, in which an inner curvature radius of the connection conductor is smaller than a thickness of the resin member.

### [Aspect 9]

The inductor according to any one of Aspects 1 to 8, in which
an outer side of the connection conductor has a curved shape, and
a length dimension of the first recessed portion of the second conductor in the second direction is smaller than a curvature radius of the curved shape of the connection conductor.

### [Aspect 10]

The inductor according to any one of Aspects 1 to 9, in which
an outer side of the connection conductor has a curved shape, and
a length dimension of the first recessed portion of the first conductor in the first direction is smaller than a curvature radius of the curved shape of the connection conductor.

### [Aspect 11]

The inductor according to any one of Aspects 1 to 10, in which
the coil conductor includes
a third conductor extending in the second direction,
a fourth conductor connecting the other end portion of the second conductor and one end portion of the third conductor, and
a fifth conductor connected to the other end portion of the third conductor and extending in the first direction, and
the magnetic body is placed on the first conductor and the fifth conductor via the resin member.

### [Aspect 12]

A DC-DC converter including the inductor of any one of Aspects 1 to 11.

### REFERENCE SIGNS LIST

1 Inductor
2A, 2B, 2C Magnetic body (magnetic body)
3A, 3B Coil conductor
6A, 6B, 6C Resin member
11A, 11B Conductor portion (second conductor, third conductor)
12A, 12B Conductor portion (second conductor, third conductor)
13A, 13B Coupling portion (fourth conductor)
14A, 14B Terminal portion (first conductor, fifth conductor)
15 Connection conductor
16A, 16B Terminal portion (first conductor, fifth conductor)
21, 22 First recessed portion
23 Second recessed portion
30 Bent portion (first conductor)
50 Burr (at least part of resin material)
60 Adhesive layer
100, 500 DC-DC converter
111 Conductor portion (first conductor, second conductor)
112 Conductor portion (second conductor)
113 Coupling portion (first conductor, second conductor)

What is claimed is:

1. An inductor comprising:
a coil conductor including a first conductor extending in a first direction, a second conductor extending in a second direction intersecting the first direction, and a connection conductor connecting one end portion of the first conductor and one end portion of the second conductor;
a magnetic body having a corner portion and disposed such that the corner portion faces the connection conductor of the coil conductor; and
a resin member disposed between the magnetic body and the first conductor of the coil conductor, wherein
at least one conductor of the first conductor and the second conductor has a first recessed portion recessed from an inside to an outside at a position adjacent to the connection conductor, and
a dimension of the first recessed portion in a third direction intersecting the first and second directions is equal to or larger than a dimension of a conductor having a shorter dimension in the third direction, of the one conductor and the other conductor, in the third direction.

2. The inductor according to claim 1, wherein at least a part of the resin member is accommodated in the first recessed portion.

3. The inductor according to claim 1, wherein the first conductor and the second conductor each have the first recessed portion recessed from the inside to the outside at a position adjacent to the connection conductor.

4. The inductor according to claim 1, wherein
the connection conductor has a second recessed portion recessed from the inside to the outside, and
the second recessed portion of the connection conductor communicates with the first recessed portion of the at least one conductor.

5. The inductor according to claim 1, wherein a length dimension of the first recessed portion of the second conductor in the second direction is larger than a thickness of the resin member.

6. The inductor according to claim 1, wherein a depth of the first recessed portion of the at least one conductor is smaller than half of a thickness dimension of the at least one conductor.

7. The inductor according to claim 1, wherein
the second conductor and the magnetic body are in close contact with each other via an adhesive layer, and
an inner curvature radius of the connection conductor is smaller than a thickness of the adhesive layer.

8. The inductor according to claim 1, wherein an inner curvature radius of the connection conductor is smaller than a thickness of the resin member.

9. The inductor according to claim 1, wherein
an outer side of the connection conductor has a curved shape, and
a length dimension of the first recessed portion of the second conductor in the second direction is smaller than a curvature radius of the curved shape of the connection conductor.

10. The inductor according to claim 1, wherein
an outer side of the connection conductor has a curved shape, and
a length dimension of the first recessed portion of the first conductor in the first direction is smaller than a curvature radius of the curved shape of the connection conductor.

11. The inductor according to claim 1, wherein
the coil conductor includes
a third conductor extending in the second direction,
a fourth conductor connecting the other end portion of the second conductor and one end portion of the third conductor, and
a fifth conductor connected to the other end portion of the third conductor and extending in the first direction, and
the magnetic body is placed on the first conductor and the fifth conductor via the resin member.

12. A DC-DC converter comprising the inductor according to claim 1.
